(19) United States
(12) Patent Application Publication
(10) Pub. No.: US 2007/0148567 A1
(43) Pub. Date: Jun. 28, 2007

(54) Method and apparatus for laser-drilling an inkjet orifice in a substrate

(76) Inventors: Joerg Ferber, Angerstein (DE); Hiroshi Shimizu, Tokyo (JP)

Correspondence Address: STALLMAN & POLLOCK LLP, 353 SACRAMENTO STREET, SUITE 2200, SAN FRANCISCO, CA, 94111, US

(21) Appl. No.: 11/298,281

(22) Filed: Dec. 9, 2005

(51) Int. Cl. G03C 5/00

(52) U.S. Cl. 430/30

(57) ABSTRACT

An inkjet aperture in a substrate has a compound cross-section including a circular portion and an elongated trough-shaped portion. The aperture is formed in the substrate by laser drilling. A laser beam is projected on a mask having circular apertures corresponding to the circular portion of the inkjet aperture cross-section. An image of the mask is projected by a lens onto the substrate while reciprocally tilting a tiltable plate between the mask and the lens. This forms the trough-shaped portion of the aperture. The tiltable plate is then replaced by a fixed plate of equal thickness and the circular portion of the aperture is drilled to complete the aperture.

### TECHNICAL FIELD OF THE INVENTION

The present invention relates in general to laser-drilling of an aperture through a substrate. The invention relates in particular to excimer-laser drilling an aperture having a compound cross-section wherein one portion of the cross-section has an elongated form of another portion.

### DISCUSSION OF BACKGROUND ART

An excimer laser emitting pulsed radiation in the ultraviolet (UV) region of the electromagnetic spectrum can be used to simultaneously drill a plurality of relatively small apertures, for example having a diameter less than about 50 micrometers (μm), in a substrate. In a preferred method for such simultaneous aperture drilling, UV radiation from the excimer laser is used to illuminate a mask having a plurality of apertures therein, and an image of the mask, i.e., of the apertures in the mask is projected onto the substrate using a reduction lens, for example a 5-times reduction lens. A plurality of pulses are delivered from the laser and the intensity of radiation in the mask-aperture images is sufficient that substrate material is eroded away, and the aperture-images within a few seconds, produce corresponding actual apertures in the substrate.

This method is particularly suited to drilling a plurality of apertures having the same cross-section form throughout the depth of the aperture, i.e., throughout the depth of the substrate. The method becomes much more difficult to implement if the apertures to be drilled have a compound form including a change of cross-section form at some point in the depth of each aperture. One such compound form is the form of an inkjet aperture. In certain examples, an inkjet aperture has one portion having a circular (rotationally symmetric) cross-section surmounted by a portion having an elongated trough-shaped or “bathtub”-shaped (non rotationally-symmetric) cross-section. The smallest dimension (diameter) of such an aperture is usually between about 20 μm and 50 μm. Depending on the design of a particular inkjet head as many as 300 apertures may have to be drilled in an area of approximately 0.5 millimeters (mm)×15 mm.

One possible method for forming a plurality of such complex apertures is to drill a plurality of elongated troughs having the elongated cross-section in the substrate using a first mask having a corresponding plurality of trough-shaped apertures therein. After the troughs are drilled in the substrate, the first mask is replaced with a second mask having a plurality of circular apertures therein corresponding to the circular cross-section portion the apertures and the circular portions are drilled from the base of the troughs completely through the substrate.

This method has a disadvantage that the first and second masks must be precisely registered in the drilling apparatus such that the first and second portions of the drilled apertures are correctly aligned. Another disadvantage of the method is that, however precisely the registration can be effected, the operation of changing and registering the masks tasks time, and this adds to production costs. There is a need for a method and apparatus for laser-drilling such compound apertures without a need to employ multiple masks.

### SUMMARY OF THE INVENTION

The present invention is directed to drilling an aperture in a substrate, the aperture having a compound cross-section, comprising first and second cross-section portions. In one aspect of the invention a method of drilling the aperture comprises illuminating a mask with a sequence of laser pulses. The mask has an aperture therein having a shape corresponding to the shape of the second cross-section portion. A projection lens is used to project a sequence of images of the mask aperture on the substrate corresponding to the sequence of laser pulses illuminating the mask.

The first cross-section portion of the aperture is drilled by locating a first transparent plate in an optical path of the laser pulses between the mask and the projection lens, and tilting the plate with respect to the optical path such that mask-aperture images from the sequence thereof are scanned to different overlapping locations over the substrate.

The second cross-section portion is drilled by locating a second transparent plate, instead of the first transparent plate, in the optical path between the mask and the projection lens, the second transparent plate having a fixed alignment with the optical path such that mask-aperture images from the sequence thereof are formed in a fixed location on the substrate. The second transparent plate has about the same optical thickness as the first transparent plate such that the optical distance between the mask and the projection lens is about the same, whichever of the plates is located in the optical path.

In one embodiment of apparatus in accordance with the present invention, the first and second transparent plates are mounted on a common platform. The platform is translatable transverse to the optical path of the pulses for locating either the first transparent plate or the second transparent plate in the optical path of the pulses.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1A is a fragmentary cross-section view schematically illustrating the cross-section form of an inkjet aperture to be laser drilled by apparatus in accordance with the present invention, the aperture having a compound cross-section including a circular portion and a bathtub-shaped portion.

FIG. 1B is a fragmentary cross-section view seen generally in the direction 1B-1B of FIG. 1A schematically illustrating more detail of the cross-section form of the inkjet aperture of FIG. 1A.

FIG. 1C is a fragmentary plan view seen in the direction 1C-1C of FIG. 1B schematically illustrating further detail of the cross-section form of the inkjet aperture of FIG. 1B.

FIG. 2 schematically illustrates one preferred embodiment of apparatus in accordance with the present invention having an optical system including an excimer laser delivering a laser-beam, beam shaping and homogenizing optics projecting the laser beam onto a mask, imaging optics projecting an image of the mask on a substrate, and a platform including two transparent plates selectively locatable on the system axis between the mask and the imaging optics with one plate fixedly mounted on the platform and the other plate tiltable about an axis perpendicular to the system axis for causing motion of the mask image on the substrate.

FIG. 2A schematically illustrates further detail of the platform, and the fixed and tiltable plates thereon of FIG. 3.

FIG. 2B is a fragmentary view schematically illustrating details of motion of the mask image on the substrate in the apparatus of FIG. 2 in response to tilting the tiltable plate.

FIG. 3A is a fragmentary cross-section view schematically illustrating the cross-section form of an hypothetical aperture to be laser drilled by apparatus in accordance with the present invention, the aperture having a compound cross-section including a square portion and an elongated rectangular portion.

FIG. 3B is a fragmentary cross-section view seen generally in the direction 3B-3B of FIG. 3A schematically illustrating more detail of the cross-section form of the aperture of FIG. 3A.

FIG. 3C is a fragmentary plan view seen in the direction 3C-3C of FIG. 3B schematically illustrating further detail of the cross-section form of the aperture of FIG. 3B.

### DETAILED DESCRIPTION OF THE INVENTION

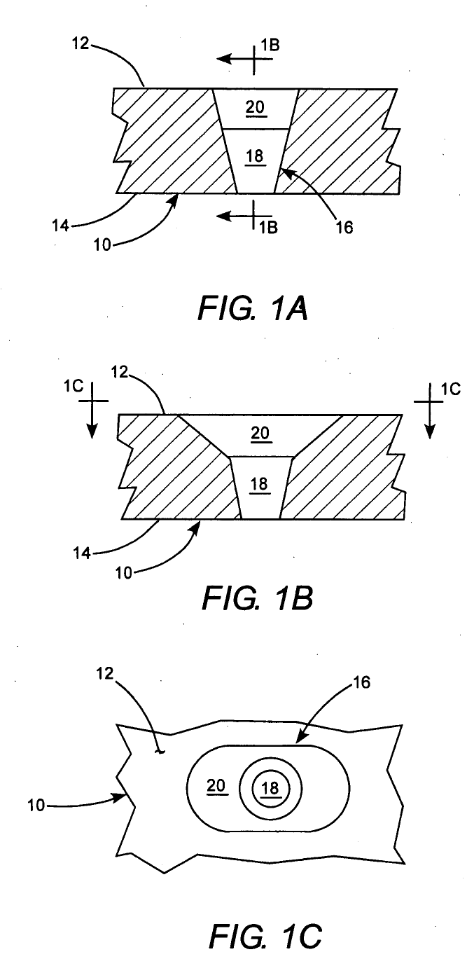

Referring now to the drawings, wherein like components are designated by like reference numerals, FIG. 1A, FIG. 1B, and FIG. 1C schematically illustrate one example of an inkjet aperture 16 suitable for drilling by the method of the present invention. The aperture is formed in a polyimide substrate 10 having an upper surface 12 and a lower surface 14. A usual thickness for such a substrate is about 50 μm.

Inkjet aperture 16 has a cross-section including a circular (rotationally-symmetrical) portion 18 surmounted by and bathtub-shaped or elongated trough-shaped (non rotationally symmetrical) portion 20. By way of example, trough-shaped portion 20 at surface 12 may have a length of about 100 μm and a width of about 50 μm. Circular portion 18 tapers from a diameter of about 40 μm to a diameter of about 20 μm at lower surface 14 of substrate 10.

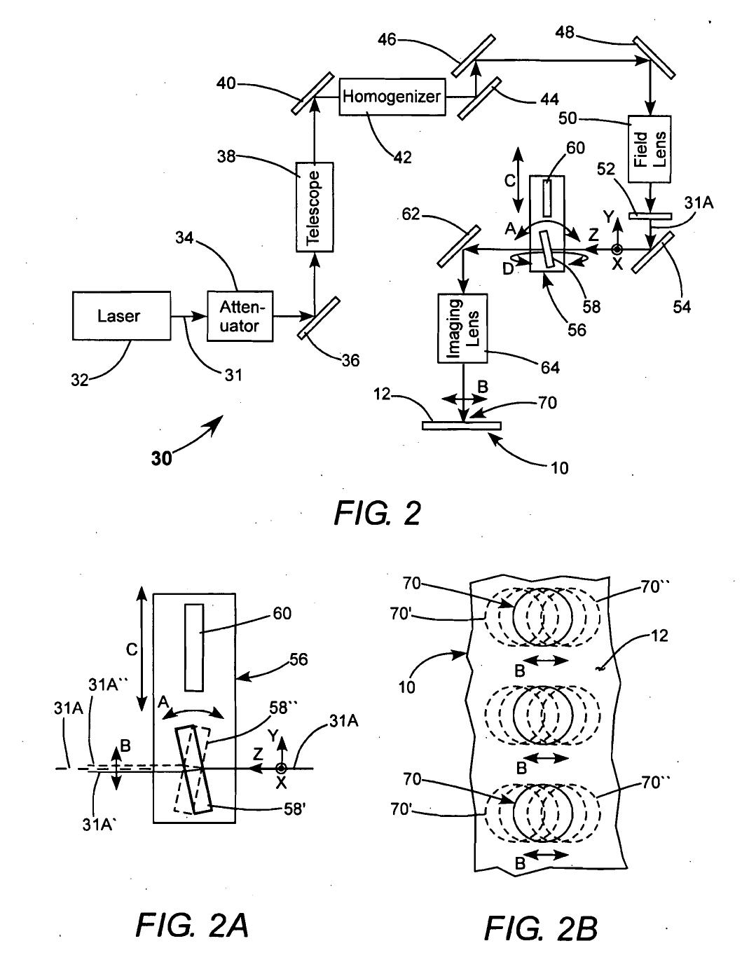

FIG. 2 and FIG. 2A schematically illustrate one preferred embodiment 30 of an optical system in accordance with the present invention for drilling a complex aperture such as inkjet aperture 16. In system 30 a laser 32 delivers a laser beam 31. The laser beam is passed through a variable attenuator 34 and directed by a turning-mirror 36 into a telescope 38. After traversing telescope 38, the beam is directed by a turning-mirror 40 into a beam homogenizer 42. The beam is then directed by turning-mirrors 44, 46, and 48 traverses a field lens unit 50 and illuminates a mask 52. Attenuator 34 allows power in the beam at mask 52 to be adjusted according to the application. Telescope 38 adapts the beam to the aperture of homogenizer 42. Homogenizer 42 redistributes energy in the beam such that the beam on the mask has a nearly uniform intensity distribution, for example a 2σ uniformity of about 2% where σ is the standard deviation from the mean. Turning-mirrors of the optical system function primarily to accommodate an optical system having a relatively long (for example, two or three meters long) optical path into a convenient volume. Optical systems for projecting a laser beam onto a mask are well known in the art and a detailed description thereof are not necessary for understanding principles of the present invention. Accordingly a detailed description of the attenuator, telescope, homogenizer and field lens of optical system 30 is not presented herein.

Mask 52 has circular apertures (not shown) therein corresponding to the rotationally symmetric portions 18 of apertures 16 to be drilled in substrate 10. The path of light passing through these apertures is designated in FIGS. 2 and 2A by a beam path (beam) 31A. Beam 31 has transverse X and Y-axes perpendicular to each other, and propagates along a Z-axis perpendicular to the X and Y-axes. Beam 31A is directed by turning mirrors 54 and 62 to an imaging lens 64, which images the beam, i.e., forms an image (designated by general numeral 70) of apertures in mask 52, on substrate 10. A description of the design of imaging lens 64 is not necessary for understanding principles of the present invention and accordingly is not presented herein. Lens 64, in most applications will be a reducing lens, for example, having a reducing factor between about five.

Located between turning mirrors 54 and 62, i.e., between mask 52 and imaging lens 64, is a platform or carrier 56 having transparent plates 58 and 60 mounted thereon. Plates 58 and 60 have about equal thickness and preferably have parallel entrance and exit surfaces. Plate 58 is reciprocally tiltable about an axis parallel to the X-axis of beam 31 as indicated in FIG. 2 by double arrows A. In most applications of the present invention the maximum tilt of the plate 58 will not be greater than a few degrees, for example, not greater than about 5° on either side of a nominal central alignment position. Preferably the nominal central alignment position is perpendicular to the beam 31A. The rate of reciprocation is preferably relatively slow, for example, a few Hz. Accordingly, the reciprocal tilting can be accomplished by several well-known means including a piezo-electric actuator, a stepper motor driving directly, or a crank-drive for converting rotary motion of a motor to a lateral motion. A particular drive mechanism is not shown in FIGS. 2 and 2A for simplicity of illustration.

Tilting plate 58 causes lateral, linear, displacement of beam 31A in the Y-axis direction as indicated in FIGS. 2 and 2A by double arrows B. In FIG. 2A, plate 58 is depicted in tilted positions 58′ (solid outline) and 58′ (dashed outline). These tilted positions give rise to laterally displaced paths 31A′ and 31A″ respectively of (the path of) beam 31A. Reciprocal lateral displacement of the beam between the mask and the imaging lens gives rise to a corresponding reciprocal lateral displacement of the images 70 of apertures in the mask on substrate 10. By way of illustration, FIG. 2B schematically illustrates three un-displaced aperture-images 70 depicted in solid outline, with extreme laterally displaced images 70′ and 70″, and intermediate displaced images, depicted in dashed outline. It should be noted, here, however, that the displacement of images 70′ and 70″ will be less than the displacement of corresponding beam paths 31A′ and 31 ″ by the reduction factor of imaging lens 64.

Regarding values for tilt and displacement, for a plate 58 made from a material having a refractive index of about 1.5, the displacement of beam 31 between the plate and the imaging lens will be about 5.8 μm per degree, per millimeter thickness of the plate. So, for example, if lens 64 has a reduction factor of 5.0 (a magnification of 0.2) and plate 58 has a thickness of 10 mm, a tilt of 2° will produce a displacement of about 23.2 μm.

Now, in one preferred method for drilling of a complex aperture exemplified by aperture 16 of FIGS. 1A-C, trough-shaped portion 20 of the aperture is first drilled while reciprocally tilting plate 58 to cause motion of the circular mask-aperture images 70 on substrate 12 as illustrated in FIG. 2B. Laser 32 is operated in a repetitive pulsed mode and preferably delivers pulses at pulse-repetition frequency (PRF) between about 250 Hz and 300 Hz, although this value should not be construed as limiting the present invention. Each pulse of course produces a corresponding mask-aperture image on the substrate. The reciprocation or oscillation rate of plate 50 is preferably about 10.0 Hz, i.e., about 4% of the PRF of laser 32. Preferably the PRF is at least about twice, and most preferably at least about 10 times, the reciprocation rate of plate 58, such that the mask aperture images at least partially overlap. About 100 pulses are required to form trough-shaped portion 20. Reciprocal motion of the beam provides that less pulses are incident on the ends of trough-shaped portion 20 than at the center thereof. This usually provides a taper angle of the trough in the Y-Z plane of about of 45°. This taper angle is dependent, among other factors, on the maximum tilt angle of plate 58, the thickness of plate 58, the energy density in the beam, and the material of the substrate.

After trough-shaped portion 20 is formed, platform 56 is translated to remove reciprocally tiltable plate 58 from beam path 31A and insert fixed plate 60 into the beam path. Surfaces of plate 60 are aligned in the nominal central alignment of the tiltable plate, which is preferably perpendicular to the beam (pulses) path and the plate does not cause any lateral displacement of the beam. Translation of the platform can be effected by any well-known means, for example, a pneumatic actuator.

With fixed plate 60 in position in beam 31A, apertures 16 are completed by drilling circular portion 18 thereof. The slope of side-walls of aperture-portion 18, and the X-Y plane slope of walls of trough-shaped portion 20, is about 10° and results from phenomena associated with laser drilling at excimer wavelengths. These phenomena are known to those skilled in the art and include, in particular, the aperture acting as a light pipe and concentrating the beam as the aperture becomes deeper. A sidewall slope can be advantageous in an inkjet aperture.

As plate 60 has essentially the same optical thickness as plate 58, the optical distance of mask 52 from imaging lens 64 (the object distance) is essentially the same with either plate the in the beam path. Accordingly, the focused image of the mask is essentially the same distance (the image distance) from imaging lens 64 with either tiltable plate 58 or fixed plate 60 the in the beam path.

The use of a fixed plate for maintaining a fixed image distance is preferred because repeatably stopping tiltable plate 58 in a fixed alignment is difficult. It is evident from the above-presented discussion of the displacement as a function of tilt angle of plate 58 that a plate alignment error of as little as one-half of one degree could cause a beam alignment (displacement) error of about 5 μm. It may be possible to provide a beam position sensor and a feedback loop for the drive mechanism of plate 58 to control the plate alignment, but this would add considerably to the cost and complexity of the apparatus. Repositioning a fixed place in the previous location of the tiltable plate with a fixed plate provides a simple effective means of guaranteeing alignment of the beam of drilling operations in which beam scanning is not required.

Regarding any difference in physical thickness of the plates is concerned, this can be minimized, for example, to within about one-wavelength, by fabricating a single parallel plate and cutting plates 58 and 60 from that single plate. While tilting plate 58 will cause a finite optical path increase for beam 31A, this path increase will be essentially negligible. By way of example, tilting the plate will cause a path change of about 0.17 μm per degree, per mm of plate thickness for a plate having a refractive index of about 1.5. This translates for a plate having a thickness of 10.0 mm to an image plane shift of only about 0.7 μm (about three wavelengths) for an imaging lens 60 having a magnification of 0.2 (5-times reduction).

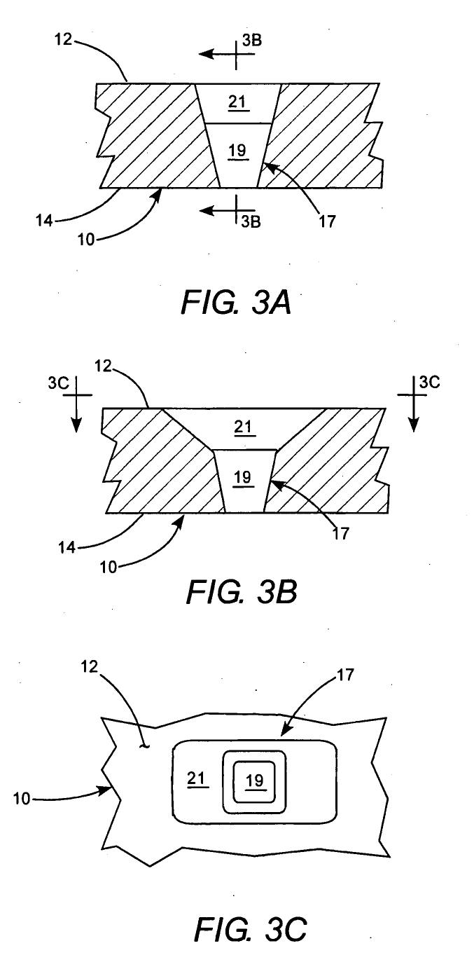

Those skilled in the art will recognize that while the method and apparatus of the present invention are described above in the context of drilling a particular form of inkjet aperture having a compound cross-section including a circular portion and an bathtub-shaped portion, the invention is applicable to drilling an aperture having any compound cross-section wherein one is an elongated form of another. By way of example, FIGS. 3A-C depict an aperture 17 having a compound cross-section including a square portion 19 and an elongated portion 21. This aperture could be drilled by above-described apparatus and a mask including a square aperture. Elongated portion 21 of the aperture would be drilled while reciprocally tilting plate 58. Plate 58 would then be replaced by fixed plate 60 and the aperture completed by drilling square portion 19 thereof.

In the example of apparatus 30 presented above tiltable plate 58 is described as being reciprocally tilted about one transverse axis only to provide an elongated portion of an aperture. Those skilled in the art will recognize, however, that the plate could be made tiltable about both transverse axes (as indicated by arrows A and D in FIG. 2) such that bi-axial beam displacement with repeated pulses could be used to provide an aperture portion having a cross-section portion that was enlarged in both transverse axes compared with that of the mask aperture and not necessarily symmetrical. It would still be necessary to replace the tiltable plate with fixed plate 60 when drilling that portion of the aperture having a cross-section corresponding to the mask aperture.

The present invention is described above in terms of a preferred and other embodiments. The invention is not limited, however, to the embodiments described and depicted. Rather, the invention is limited only by the claims appended hereto.

What is claimed is:

1. A method of drilling an aperture in a substrate, the aperture having a compound cross-section comprising first and second cross-section portions, the method comprising the steps of:
illuminating a mask with a sequence of laser pulses, said mask having an aperture therein having a shape corresponding to the shape of the second cross-section portion;
using a projection lens, projecting a sequence of images of said mask aperture on the substrate corresponding to said sequence of laser pulses illuminating the mask;
drilling the first cross-section portion of the aperture by locating a first transparent plate in an optical path of said laser pulses between said mask and said projection lens, and varying the tilt angle of said first transparent plate with respect to said optical path such that said mask-aperture images from said sequence thereof are scanned to different overlapping locations over the substrate; and
drilling the second cross-section portion of the aperture by locating a second transparent plate, instead of said first transparent plate, in the optical path between the mask and the projection lens, said second transparent plate having a fixed alignment with said optical path such that mask-aperture images from said sequence thereof are formed in a fixed location on the substrate, and said second transparent plate having about the same optical thickness as said first transparent plate such that the optical distance between said mask and said projection lens is about the same whichever of said first and second transparent plates is located in said optical path.

2. The method of claim 1, wherein said fixed alignment of said second transparent plate is perpendicular to said optical path.

3. The method of claim 2, wherein the tilt angle of said first optical plate is varied reciprocally and linearly.

4. The method of claim 3, wherein said mask aperture is circular, said first cross-section portion of the aperture has an elongated trough-shaped cross-section, and said second cross-section portion of the aperture has a circular cross-section

5. The method of claim 4, wherein pulses in said sequence are delivered at a frequency about 10 or more times greater than the reciprocal variation rate of said first transparent plate.

6. The method of claim 1, wherein the aperture is one of a plurality of essentially identical apertures to be drilled in the substrate, said mask has a plurality of essentially identical apertures therein corresponding to said plurality of apertures to be drilled in the substrate, and wherein said first portions of said substrate apertures are simultaneously drilled, and said second portions of said substrate apertures are simultaneously drilled.

7. A method of drilling an aperture in a substrate, the aperture having a compound cross-section comprising first and second cross-section portions, with the first cross-section portion being an elongated form of the second cross-section portion, the method comprising the steps of:
illuminating a mask with a sequence of laser pulses, said mask having an aperture therein having a shape corresponding to the shape of the second cross-section portion;
using a projection lens, projecting a sequences of images of said mask aperture on the substrate corresponding to said sequence of laser pulses illuminating said mask;
drilling the first cross-section portion of the aperture by locating a tiltable transparent plate in an optical path of said laser pulses between said mask and said projection lens, and reciprocally tilting said plate such that said mask-aperture images from said sequence thereof are scanned linearly in an overlapping manner over the substrate; and
drilling the second cross-section portion by locating a fixed transparent plate having about the same optical thickness as the tiltable transparent plate, instead of said tiltable transparent plate, in said optical path between said mask and said projection lens, such that mask-aperture images from said sequence thereof are formed in a fixed location on the substrate.

8. The method of claim 7, wherein said sequence of pulses is delivered at a pulse repetition frequency at least about ten times greater than the reciprocation frequency of said tiltable plate.

9. The method of claim 7, wherein said fixed plate is reciprocally tilted by an angle to said optical path no greater than about 5 degrees on either side of a central alignment angle.

10. The method of claim 9, wherein said fixed plate is fixedly aligned to said optical path at said central alignment angle.

11. The method of claim 10, wherein said central alignment angle is perpendicular to said optical path.

12. The method of claim 7, wherein said first cross-section portion of the aperture is drilled prior to drilling said second cross-section portion of the aperture.

13. The method of claim 7, wherein the said mask aperture is circular, the first cross-section portion has an elongated trough-shape, and the second cross-section portion has a circular cross-section.

14. Laser apparatus for drilling an aperture in a substrate, comprising:
a mask having an aperture therein having a shape corresponding to a cross-section shape of the aperture;
a laser arranged to deliver a sequence of laser pulses;
optics arranged to receive said sequence of pulses and direct said sequence of laser pulses to the mask for illuminating the mask;
an imaging lens arranged to project a sequences of images of said mask aperture on the substrate, said sequence of images corresponding to said sequence of laser pulses illuminating said mask;
first and second transparent plates alternatively locatable in an optical path of said laser pulses between said mask and said imaging lens;
said first plate having a fixed alignment with respect to said optical path such that when said first plate is located in said optical path mask-images from said sequence thereof are incident in the same location on said substrate;
said second plate having a tiltably mounted with respect to said optical path such that when said second plate is located in said optical path and said plate is tilted through a range of angles, mask-images from said sequence thereof are scanned to different locations on said substrate; and
wherein each of said first and second plates has about the same optical thickness, such that the optical distance from said mask to said imaging lens is about the same whichever of said plates is located in said optical path.

15. The apparatus of claim 14, wherein said second plate has a reciprocally variable tilt angle with respect to said optical path and configured such that scanned images are reciprocally, linearly scanned over said substrate.

16. The apparatus of claim 15, wherein said first and second plates are mounted on a platform translatable in a direction transverse to said optical path for alternatively locating one or the other thereof in said optical path.

17. The apparatus of claim 15, wherein said aperture in said mask is one of a plurality of identical apertures in said mask.

18. A mechanism for scanning a laser beam in order to drill a workpiece comprising:
a carrier;
a first transparent plate tiltably mounted on said carrier;
means for causing the tiltable plate to reciprocate;
a second transparent plate fixedly mounted on said carrier, said second transparent plate having the same optical thickness as the first transparent plate; and
means for moving the carrier to selectively align one of the first and second plates with the laser beam whereby in operation, the carrier is positioned to align the first tiltable plate with the laser beam so that when the plate is reciprocated, the laser beam will be scanned over the workpiece to drill the first portion of a hole to first depth and an extended width and thereafter the carrier is positioned to align the second fixed plate with the laser beam in order to drill a second portion of the hole deeper into the workpiece, said second portion of the hole being located within the area of the first portion of the hole and having a smaller diameter than the first portion of the hole.
